(19) United States
(12) Patent Application Publication
(10) Pub. No.: US 2015/0145322 A1
(43) Pub. Date: May 28, 2015

(54) PRESSURE DAMPING DEVICE FOR BRAKE SYSTEM

(71) Applicant: MANDO CORPORATION, Pyeongtaek-si (KR)

(72) Inventors: Soo-Yong JEON, Gunpo-si (KR); Chun-Sic Yun, Yongin-si (KR)

(21) Appl. No.: 14/307,926

(22) Filed: Jun. 18, 2014

(30) Foreign Application Priority Data
Nov. 26, 2013 (KR) 10-2013-0144334

(51) Int. Cl. B60T 13/14

(52) U.S. Cl. CPC B60T 13/148; B60T 13/142
USPC 303/10

(57) ABSTRACT

Disclosed herein is a pressure damping device for a brake system which may reduce pressure pulsations generated by a piston pump. The pressure damping device is installed at a brake system having a hydraulic block provided with a first hydraulic circuit to control transfer of fluid pressures generated at a first port of a master cylinder and discharged from a first pump, and a second hydraulic circuit to control transfer of fluid pressures generated by a second port of the master cylinder and discharged from a second pump. The hydraulic block is provided with a bore connecting the master cylinder with a discharge outlet of each of the pumps and formed between main oil channels. The pressure damping device is provided in the bore, has a changeable volume, and includes a stopper member and a damping member. The damping member includes a ring-shaped elastic member and a plate.

### CROSS-REFERENCE TO RELATED APPLICATION(S)

This application claims the benefit of Korean Patent Application No. 2013-0144334, filed on Nov. 26, 2013 in the Korean Intellectual Property Office, the disclosure of which is incorporated herein by reference.

### BACKGROUND

1. Field

Embodiments of the present invention relate to a pressure damping device for a brake system which may reduce pressure pulsations generated by a piston pump driven by a motor when the brake system operates.

2. Description of the Related Art

Vehicles are essentially equipped with a hydraulic brake system to perform braking. Recently, various kinds of systems have been proposed to obtain stronger and more stable braking force. Examples of hydraulic brake systems include an anti-lock brake system (ABS), which prevents wheel slippage in braking, a brake traction control system (BTCS), which prevents slippage of drive wheels during sudden start or sudden acceleration, and an electronic stability control (ESC) system, which maintains vehicle stability by controlling brake fluid pressure with a combination of the ABS and the BTCS.

Such hydraulic brake systems include a master cylinder to generate pressure necessary for braking, a plurality of solenoid valves to regulate hydraulic braking pressure transferred to a wheel brake of the vehicle, a low-pressure accumulator to temporarily store oil, a pump and motor to forcibly pump out the oil stored in the low-pressure accumulator, an orifice to reduce pressure pulsation of the oil pumped out by the pump, and an electronic control unit (ECU) to electrically control driving of the solenoid valves and the pump. The valve assembly of the solenoid valves, the accumulator, the pump and the motor are installed in a compact form in a hydraulic block (modulator block), which is made of aluminum. The ECU is provided with an ECU housing equipped with a coil assembly for the solenoid valves and a circuit board and is coupled to the hydraulic block.

In the conventional hydraulic brake system as above, sudden pressure pulsation, which occurs when the pump is driven to increase the braking pressure, is reduced by an orifice arranged at the discharge outlet of the pump. However, this orifice is simply designed to adjust the cross-sectional area of the flow passage to reduce pressure pulsation, and accordingly has a limit in completely attenuating pressure pulsation.

Another method to reduce pressure pulsation is to increase the number of pistons of the pump. This method increases the weight and volume of the module as well as the overall performance of the motor, leading to increase of manufacturing costs. If peaks of pressure pulsation caused by driving the pump continuously occurs, they may lead to generation of noise during operation of the brake system. Korean Patent No. 10-1196892 discloses a hydraulic brake system provided with a damping member to attenuate pressure pulsation generated in driving the pump to address this issue.

### CITED REFERENCE

### Patent Document

Korean Patent No. 10-1196892 (Nov. 1, 2012)

### SUMMARY

Therefore, it is an aspect of the present invention to provide a pressure damping device for a brake system which may reduce periodic pressure pulsation generated by driving a pump.

Additional aspects of the invention will be set forth in part in the description which follows and, in part, will be obvious from the description, or may be learned from practice of the invention.

In accordance with one aspect of the present invention, a pressure damping device for a brake system having a hydraulic block provided with a first hydraulic circuit to control transfer of a fluid pressure generated at a first port of a master cylinder and a fluid pressure discharged from a first pump to at least one first wheel, and a second hydraulic circuit to control transfer of a fluid pressure generated by a second port of the master cylinder and a fluid pressure discharged from a second pump to at least one second wheel, wherein the hydraulic block is provided with a bore connecting the master cylinder with a discharge outlet of each of the first and second pumps and formed between first and second main oil channels having an orifice to communicate with each of the first and second main oil channels, is provided in the bore and has a volume changed according to the fluid pressures discharged from the first and second pumps, the pressure damping device including a stopper member provided therein with a oil passage to connect the first main oil channel with the second main oil channel, the stopper member being coupled to the bore; and a damping member provided between an inner cross section of the bore having an oil passage and a cross section of the stopper member having the oil passage to shut the first and second main oil channels such that the first and second main oil channels are not connected to each other, wherein the damping member includes a ring-shaped elastic member and a plate coupled to the elastic member such that a center of the elastic member is closed.

The elastic member and the plate may be integrated with each other through insert molding.

When a pressure pulsation occurs in the first and second main oil channels, the plate may be elastically deformed to attenuate the pressure pulsation.

Opposite surfaces of the plate may be provided with a protrusion at central portions of the opposite surfaces to limit a degree of deformation of the damping member according to a pressure pulsation.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a pressure damping device provided to a brake system according to an exemplary embodiment of the present invention;

FIG. 2 is a cross-sectional view illustrating a pressure damping device for a brake system according to one embodiment of the present invention;

FIG. 3 is a perspective view illustrating a damping member according to one embodiment of the present invention;

FIG. 4 is a cross-sectional perspective view illustrating a damping member according to one embodiment of the present invention; and

FIG. 5 is a view illustrating a pressure damping device operated by a pressure pulsation according to one embodiment of the present invention.

### DETAILED DESCRIPTION

Reference will now be made in detail to the embodiments of the present invention, examples of which are illustrated in the accompanying drawings, wherein like reference numerals refer to like elements throughout.

The embodiments described in the specification and shown in the drawings are intended to provide thorough understanding of the spirit of the present invention for those skilled in the art. The present invention is not limited to the embodiments described below, but may cover other embodiments. For clarity of description, elements irrelevant to description of the present invention are omitted in the drawings. It will be appreciated that for simplicity and clarity of illustration, the dimensions of some of the elements may be exaggerated, relative to other elements in the drawings.

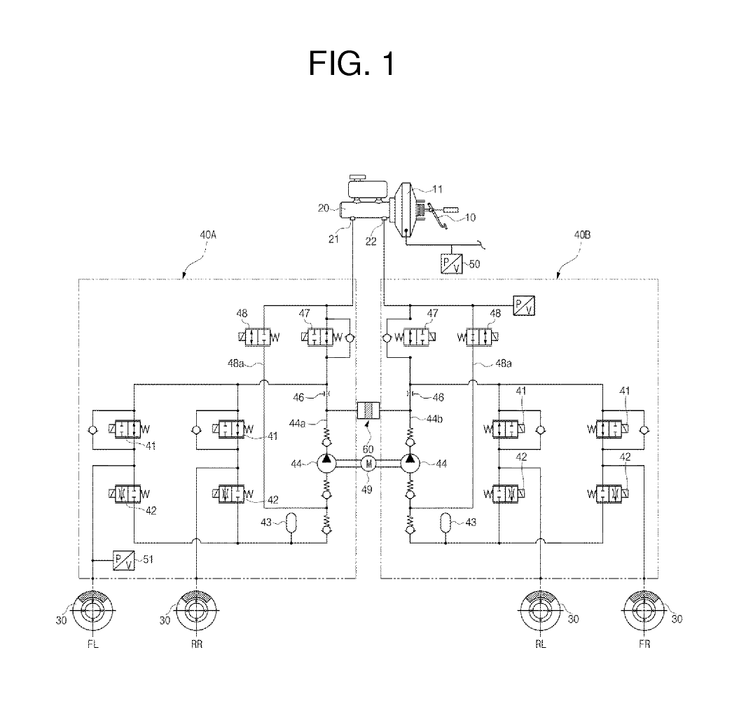

FIG. 1 is a view illustrating a pressure damping device 60 provided to a brake system according to an exemplary embodiment of the present invention.

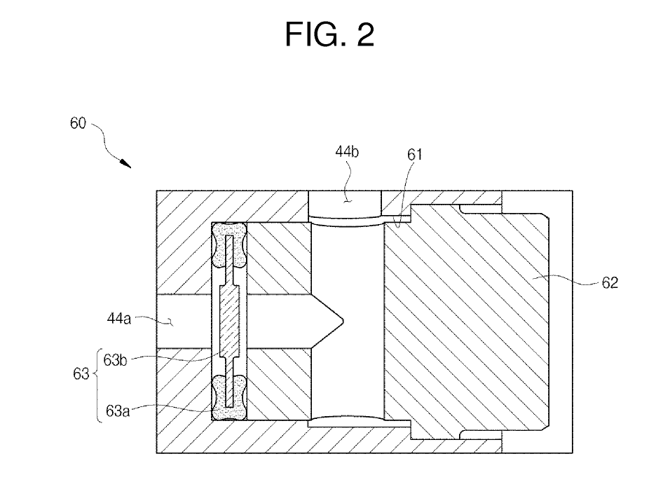

Referring to FIG. 1, the pressure damping device for a brake system according to this embodiment includes a brake pedal 10 to receive operational force from a driver, a brake booster 11 to boost foot force on the brake pedal 10 using the pressure difference between the vacuum pressure and the atmospheric pressure made by the foot force on the brake pedal 10, a master cylinder 20 to generate pressure through the brake booster 11, a first hydraulic circuit 40A to connect a first port 21 of the master cylinder 20 to two wheel brakes (wheel cylinders) 30 to control transfer of fluid pressure, and a second hydraulic circuit 40B to connect a second port 22 of the master cylinder 20 to the other two wheel brakes 30 to control transfer of fluid pressure. The first hydraulic circuit 40A and the second hydraulic circuit 40B are installed in a compact form in a hydraulic block (see FIG. 2).

Each of the first hydraulic circuit 40A and the second hydraulic circuit 40B includes solenoid valves 41 and 42 to respectively control brake oil pressure transferred to two wheel cylinders 30, a pump 44 to draw in oil from the wheel brakes 30 or the master cylinder 20 and pump the oil, a low-pressure accumulator 43 to temporarily store the oil from the wheel brakes 30, an orifice 46 to reduce pressure pulsations in the fluid pressure pumped by the pump 44, and an auxiliary channel 48a to guide the oil from the master cylinder 20 such that the oil is drawn into the inlet of the pump 44 in the TCS mode.

The solenoid valves 41 and 42, which are connected with the upstream and downstream of the wheel brakes 30, are classified into Normally-Open solenoid valves 41, which are disposed upstream of the wheel brakes 30 and kept open in normal times, and Normally-Closed solenoid valves 42, which are disposed downstream of the wheel brakes 30 and kept closed in normal times. Opening and closing of the solenoid valves 41 and 42 are controlled by an electric control unit (ECU) (not shown), which senses the speed of the vehicle through wheel speed sensors disposed at the respective wheels, and according to braking with pressure reduction, the Normally-Closed solenoid valves 42 are opened and the oil from the wheel brakes 30 is temporarily stored in the low-pressure accumulator 43.

The pump 44 is driven by a motor 45 to draw in the oil stored in the low-pressure accumulator 43 and to discharge the oil to the orifice 46 so as to transfer the fluid pressure to the wheel brakes 30 or the master cylinder 20. The pressure damping device 60 to reduce pressure pulsation by the pump 44 is provided between the discharge outlet of the pump 44 and the orifice 46. The pressure damping device 60 will be described later.

Installed in main oil channels 44a and 44b connecting the master cylinder 20 to the discharge outlets of the pumps 44 are Normally-Open solenoid valves 47 (hereinafter, referred to as TC valves) for control of a TCS. The TC valves 47 are kept open in normal times, such that, in normal braking through the brake pedal 10, the brake fluid pressure formed in the master cylinder 20 is transferred to the wheel cylinders 30 through the main oil channels 44a and 44b.

The auxiliary oil channels 48a branch from the main oil channels 44a and 44b to guide the oil from the master cylinder 20 to the inlets of the pumps 44. Shuttle valves 48 allowing the oil to flow only to the inlets of the pumps 44 are installed in the auxiliary oil channels 48a. The shuttle valves 48, which operate electrically, are installed in the middle of the auxiliary oil channels 48a such that they are kept closed in normal times and opened in the TCS mode.

Meanwhile, a pressure sensor 11, to sense the atmospheric pressure and the vacuum pressure of the brake booster 11, is installed at the brake booster 11. The brake booster 11 is also provided with a wheel pressure sensor 51 to sense actual braking pressure applied to the front left and right wheels FL and FR and the rear left and right wheels RL and RR. These pressure sensors 50 and 51 are controlled by the ECU to which the pressure sensors 50 and 51 are electrically connected.

FIG. 2 is a cross-sectional view illustrating a pressure damping device 60 for a brake system according to one embodiment of the present invention.

Referring to FIG. 2, the pressure damping device 60 is press-fitted into a bore 61 arranged to communicate with the main oil channels 44a and 44b of the first hydraulic circuit 40A and second hydraulic circuit 40B installed in a hydraulic block.

The pressure damping device 60 includes a stopper member 62 provided therein with an oil passage to connect the first main oil channel 44a and the second main oil channel 44b to each other and coupled to the bore 61, and a damping member 63 provided between the inner cross section of the bore 61 having an oil passage and one cross section of the stopper member 62 having an oil passage to shut the first and second main oil channels 44a and 44b such that the oil channels are not connected to each other.

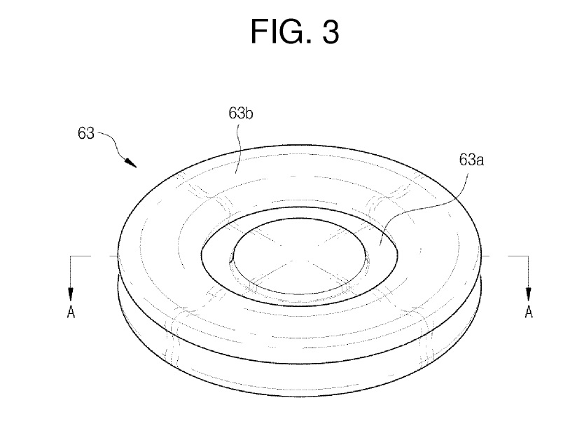

FIG. 3 is a perspective view illustrating a damping member 63 according to one embodiment of the present invention.

Referring to FIG. 3, the damping member 63 may include a ring-shaped elastic member 63a and a plate 63b coupled to the elastic member 63 so as to close the center of the elastic member 63a.

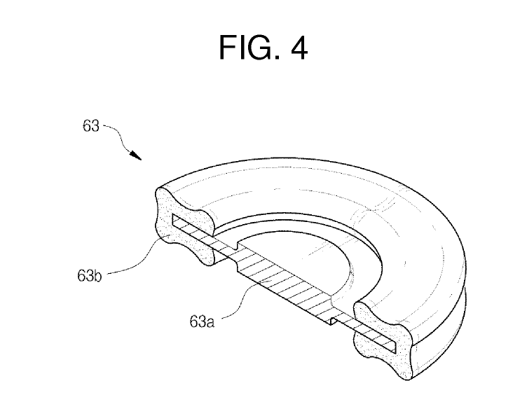

FIG. 4 is a cross-sectional perspective view illustrating a damping member 63 according to one embodiment of the present invention.

Referring to FIG. 4, the elastic member 63a and the plate 63b are integrated with each other. The elastic member 63a and the plate 63b may be integrated with each other through insert molding. Alternatively, the elastic member 63a and the plate 63b may be integrated with each other by being bonded to each other by an adhesive agent. Alternatively, the elastic member 63a and the plate 63b may be integrated with each other through high-temperature and high-pressure molding.

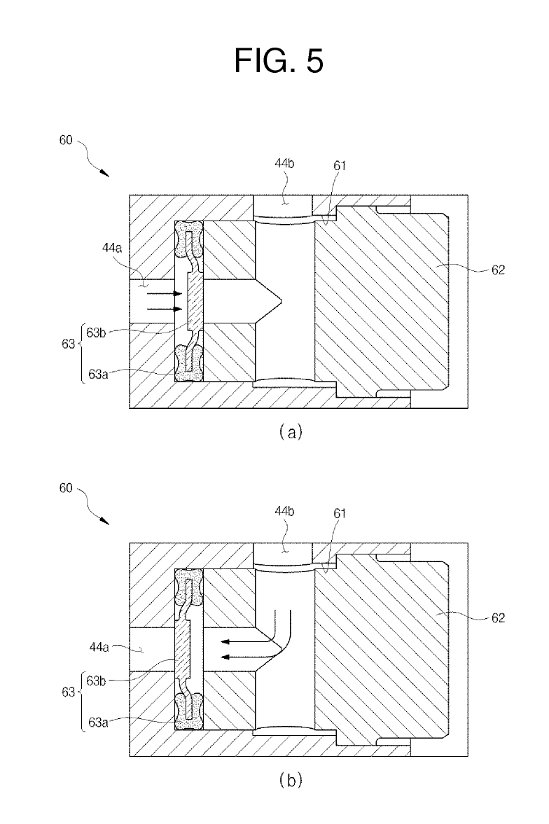

FIG. 5 is a view illustrating a pressure damping device 60 operated by a pressure pulsation according to one embodiment of the present invention.

Referring to FIG. 5, the damping member 63 may be elastically deformed according to pressure pulsation occurring in the first and second main oil channels 44a and 44b to change the volume of the oil channels. As the volume of an oil channel undergoing pressure pulsation changes, the pressure pulsation may be damped.

The elastic member 63a is adapted to be elastically deformable to allow the damping member 63 to be elastically deformed. The plate 63b is also adapted to be elastically deformable to allow the damping member 63 to be elastically deformed.

When pressure pulsation occurs in the first main oil channel 44a, the plate 63b is elastically deformed such that the volume of the first main oil channel 44a increases. When pressure pulsation occurs in the second main oil channel 44b, the plate 63b is elastically deformed such that the volume of the second main oil channel 44b increases.

The plate 63b is provided with protrusions at the central portions of both surfaces. Thereby, the plate 63b may adjust the degree of change of the volume when the pressure pulsation occurs in the first and second main oil channels 44a and 44b. That is, when the pressure pulsation occurs in the first and second main oil channels 44a and 44b, the height of the protrusions of the plate 63b is adjusted such that the protrusions of the plate 63b contact the inner surface of the bore 61 or one surface of the stopper member 62. Thereby, the degree of elastic deformation of the plate 63b is limited, and therefore the degree of change of the volume of the first and second main oil channels 44a and 44b undergoing pressure pulsation may be adjusted.

As is apparent from the above description, a pressure damping device for a brake system according to one embodiment of the present invention is provided in a bore arranged between and communicating with first and second main oil channels which connect the master cylinder to the discharge outlets of the respective pumps and are provided with orifices. Thereby, the volume of the pressure damping device changes according to the hydraulic pressure discharged from the pumps to damp the pressure pulsation caused by operation of the pumps. Accordingly, overall operational noise occurring in controlling the brake may be reduced and product reliability may be enhanced.

In addition, a pressure damping device for a brake system according to one embodiment of the present invention is provided with a fixed elastic member which has the same function as a conventional sealing member. Therefore, durability of the pressure damping device may be enhanced compared to the conventional sealing member.

In addition, a pressure damping device for a brake system according to one embodiment of the present invention limits the degree of deformation of an elastic member by changing the height of protrusions of a plate of the damping member. Therefore, durability of the elastic member may be enhanced.

Further, a pressure damping device for a brake system according to one embodiment of the present invention is provided with a damping member whose components are integrated with each other to incorporate the functions of piston, sealing member, spring and seal stopper. Thereby, the structure of the pressure damping device is simplified, and therefore the number of components may be reduced and costs may also be reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A pressure damping device for a brake system having a hydraulic block provided with a first hydraulic circuit to control transfer of a fluid pressure generated at a first port of a master cylinder and a fluid pressure discharged from a first pump to at least one first wheel, and a second hydraulic circuit to control transfer of a fluid pressure generated by a second port of the master cylinder and a fluid pressure discharged from a second pump to at least one second wheel, the pressure damping device being installed at the brake system,
wherein the hydraulic block is provided with a bore connecting the master cylinder with a discharge outlet of each of the first and second pumps and formed between first and second main oil channels having an orifice to communicate with each of the first and second main oil channels, and the pressure damping device is provided in the bore and has a volume changed according to the fluid pressures discharged from the first and second pumps,
the pressure damping device comprising:
a stopper member provided therein with a oil passage to connect the first main oil channel with the second main oil channel, the stopper member being coupled to the bore; and
a damping member provided between an inner cross section of the bore having an oil passage and a cross section of the stopper member having the oil passage to shut the first and second main oil channels such that the first and second main oil channels are not connected to each other,
wherein the damping member comprises a ring-shaped elastic member and a plate coupled to the elastic member such that a center of the elastic member is closed.

2. The pressure damping device according to claim 1, wherein the elastic member and the plate are integrated with each other through insert molding.

3. The pressure damping device according to claim 1, wherein, when a pressure pulsation occurs in the first and second main oil channels, the plate is elastically deformed to attenuate the pressure pulsation.

4. The pressure damping device according to claim 1, wherein opposite surfaces of the plate are provided with a protrusion at central portions of the opposite surfaces to limit a degree of deformation of the damping member according to a pressure pulsation.
